(19) United States
(12) Patent Application Publication
(10) Pub. No.: US 2016/0246485 A1
(43) Pub. Date: Aug. 25, 2016

(54) VISUAL REPRESENTATIONS OF MULTIVARIATE DATA INDICATING ELEMENTS OF CONTRIBUTION

(71) Applicant: BENJAMIN RIGLER HALPERN, SANTA CRUZ, CA (US)

(72) Inventor: BENJAMIN RIGLER HALPERN, SANTA CRUZ, CA (US)

(21) Appl. No.: 15/050,299

(22) Filed: Feb. 22, 2016

Related U.S. Application Data
(63) Continuation-in-part of application No. 14/246,517, filed on Apr. 7, 2014.

(51) Int. Cl. G06F 3/0484; G06T 11/00; G06T 11/20

(52) U.S. Cl. CPC G06F 3/04842; G06T 11/206; G06T 11/001; G06F 3/04845

(57) ABSTRACT

A method is presented by which data involving two or more variable quantities may be dynamically sorted and viewed by means of specific data inputs relating to contribution. A plurality of data points are selected and a first representation of the data points rendered on the screen of a computing device, whereby at least one of the pluralities of data points may be selected by a user. A second representation of the data points is additionally rendered upon a screen of a computing device. Upon selection of the at least one subset of data in the first representation, a corresponding, contributing subset is highlighted in the second representation.

### FIELD OF THE INVENTION

The present invention relates to the digital representation and manipulation of data having at least two variable quantities. More particularly, the present invention relates to means by which multivariate data may be explored by means of a plurality of data points in common between representations of data sets.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

The field of data representation and manipulation is essential to the effective functioning of both businesses and individual ventures, and data representation that is inefficient or difficult to comprehend may be a significant hindrance to the success of both individuals and businesses. The prior art, however, fails to optimally provide and method by which data representations having corresponding data points and inputs, may be connectively represented, wherein the selection of a specific data input or data input type highlights similar or identical data inputs or data input types in other representations of the data set.

There is therefore a long-felt need to provide a system and method by which multivariate data may be sorted and represented with increased ease and efficiency by means of corresponding data between two or more data representations.

### SUMMARY OF THE INVENTION

Towards these objects and other objects that will be made obvious in light of the present disclosure a process is presented by which a plurality of records, or a data set, is selected by a user or by a computing device, wherein each of the plurality of records contains data having at least two variable quantities. In the first preferred embodiment of the method of the present invention (hereinafter “invented method”), a first representation of the data set is rendered, preferably on the screen of a computing device, the computing device having a means by which as user may interact with the data representation, such as a point-and-click device. The first representation preferably demonstrates a first variable of the multivariate data. A second representation of the data set is also rendered, preferably organized by a second variable of the multivariate data. A user may subsequently select in the first representation a first subset of the first data set, and the computing device may render the degree of contribution from the first subset in the second representation. In a non-limiting example, the total sales of a plurality of employees for a firm may be represented in the first representation, and the total sales in a given geographical area may be represented in the second representation. Upon selection of a designated employee, the employee's contribution to the total sales in a given geographical area may be highlighted in the second representation.

Additionally presented is a computing device which enables the invented method. The enabling computing device preferably includes a means to select a multivariate data set, and means to visually render the first and second representations of the multivariate data set. The enabling means of the presented computing device preferably includes, but is not limited to, a computing device having a processor capable of executing the invented method, a screen on which visual representations of data may be rendered, and a means by which a user may interact with the rendered data, such as a point-and-click device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE FIGURES

These, and further features of the invention, may be better understood with reference to the accompanying specification and drawings depicting the preferred embodiment, in which:

FIG. 1 is a block diagram of a computing device designed to enable invented method;

FIG. 2A is a flowchart of an aspect of the invented method whereby data is read by the computing device, is rendered in a tabular representation, and is rendered in a plurality of charts;

FIG. 2B is a visual representation of the product of the process of FIG. 2A;

FIG. 2C shows additional detail in the visual representation of FIG. 2B;

FIG. 3A is a flowchart of an aspect of the invented method whereby the computing device receives a user input, highlights the user-selected data, and overlays the rendered charts with a representation of the data corresponding with the selected data; and

FIG. 3B is a visual representation of the product of the method of FIG. 3A, showing both the invented method and prior art methods for data visualization; and

FIG. 3C shows additional detail in the visual representation of FIG. 3B, showing only the invented method of data visualization.

### DETAILED DESCRIPTION

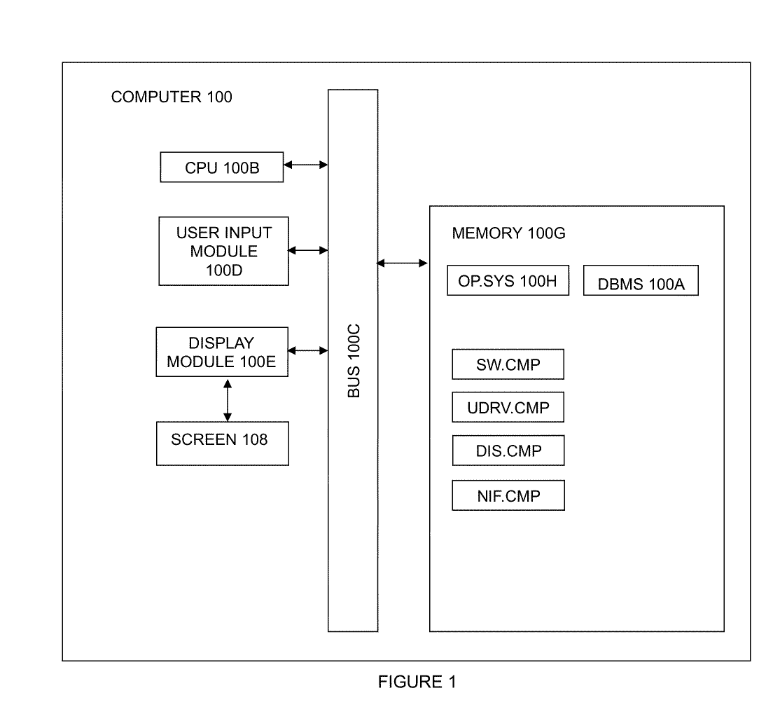

Referring now generally to the Figures, and particularly to FIG. 1, FIG. 1 is a block diagram of a computing device 100 designed to enable invented method, wherein the computing device 100 comprises a central processing unit (“CPU”) 100B; a user input module 100D; a display module 100E; a software bus 100C bi-directionally communicatively coupled with the CPU 100B, the user input module 100D, the display module 100E; and a memory 100G. The remote software bus 100C facilitates communications between the above-mentioned components of the computing device 100. The computing device 100 further includes a screen 108 bidirectionally coupled to the display module 100E, on which a user may view visual representations of data as described by the invented method.

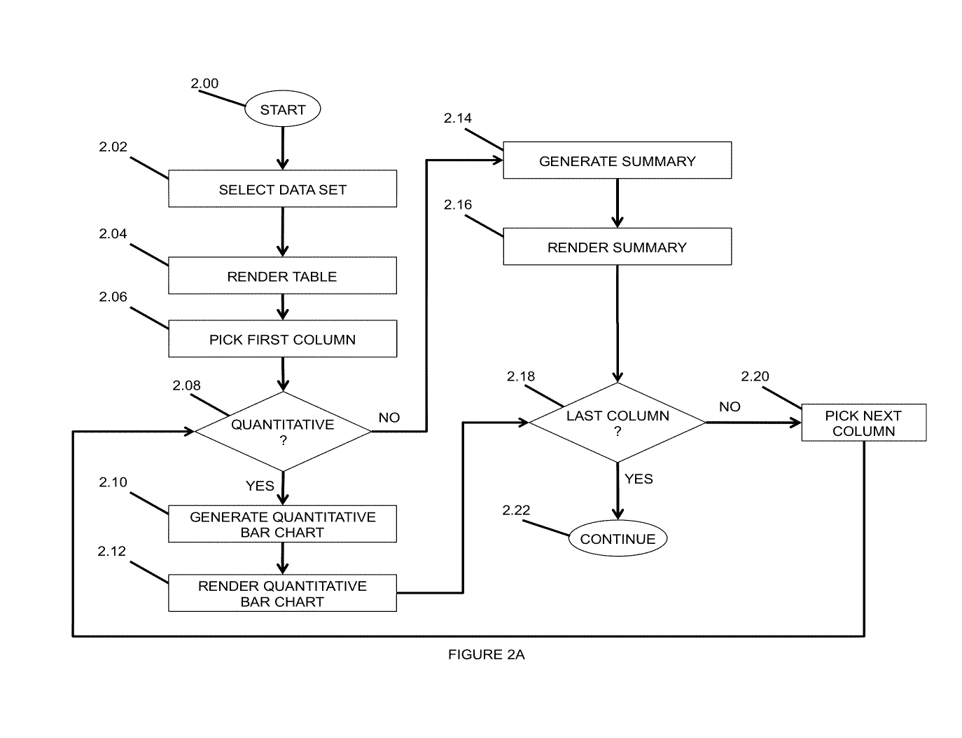

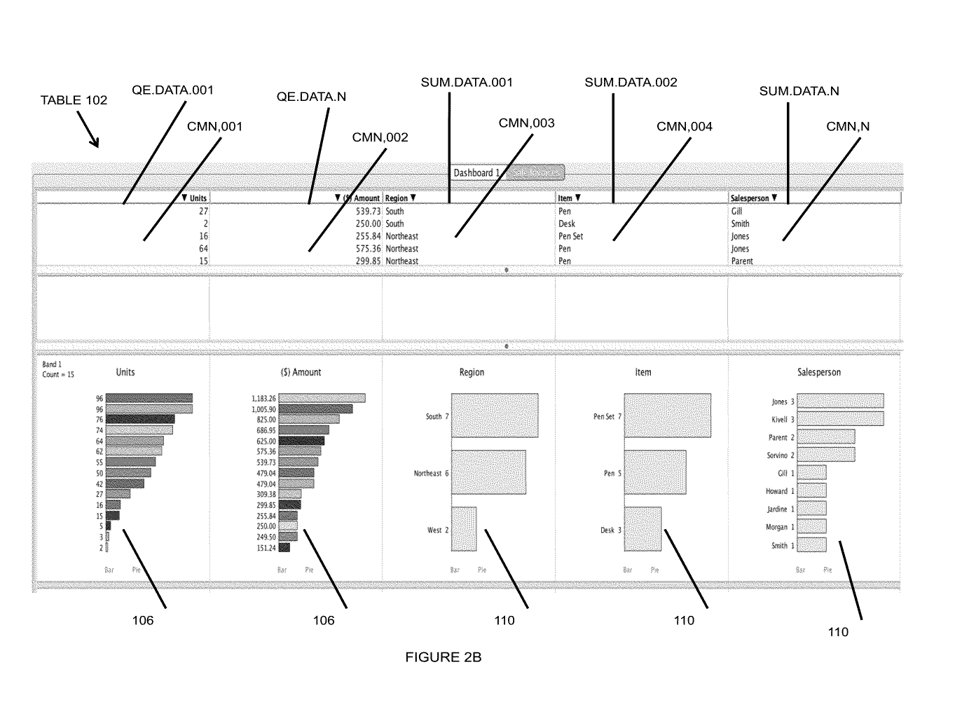

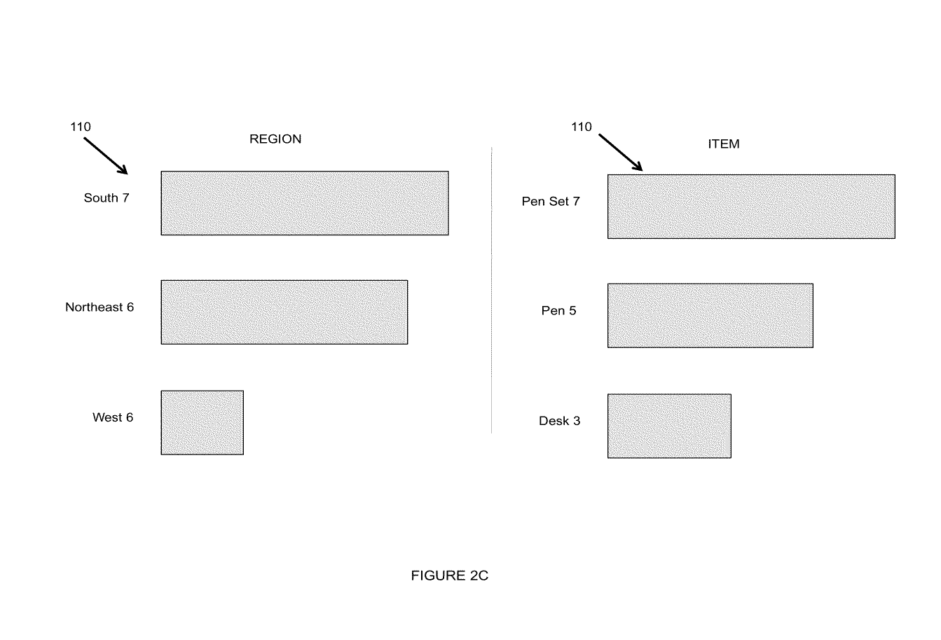

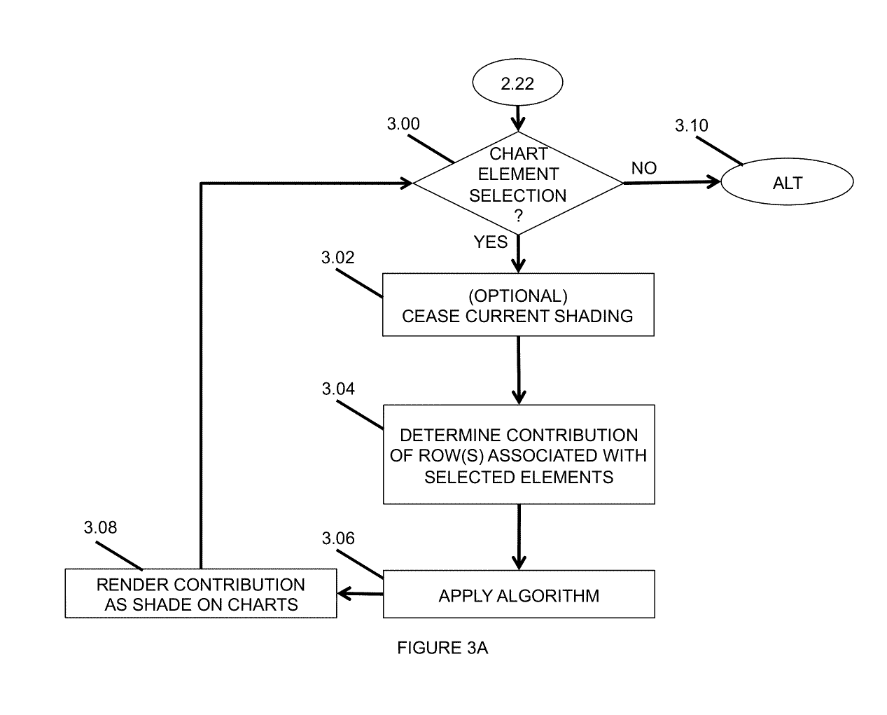

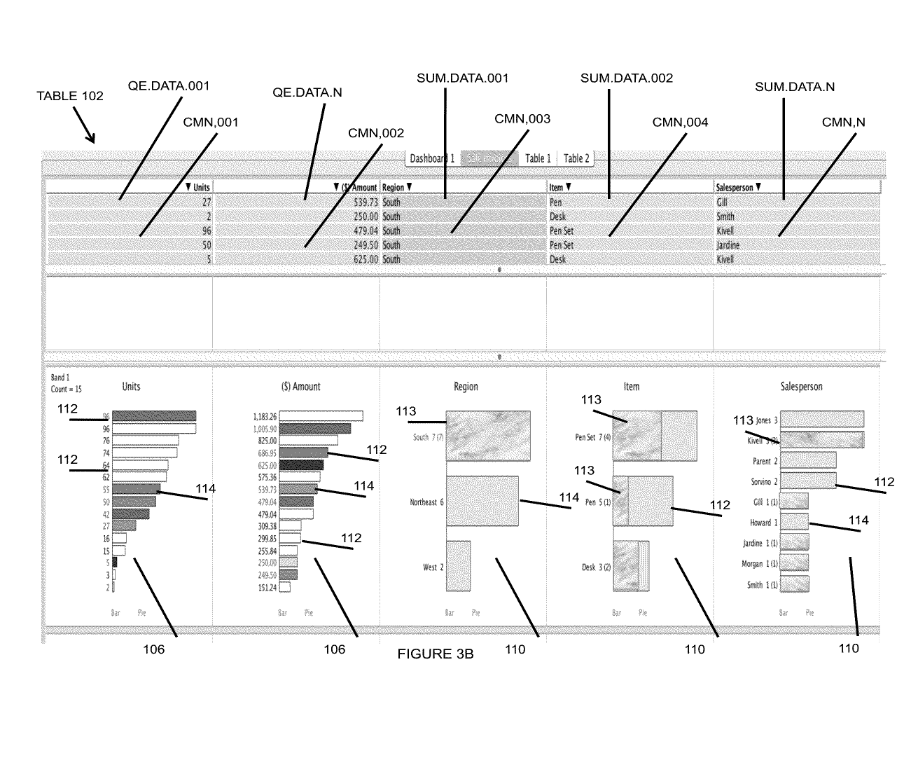

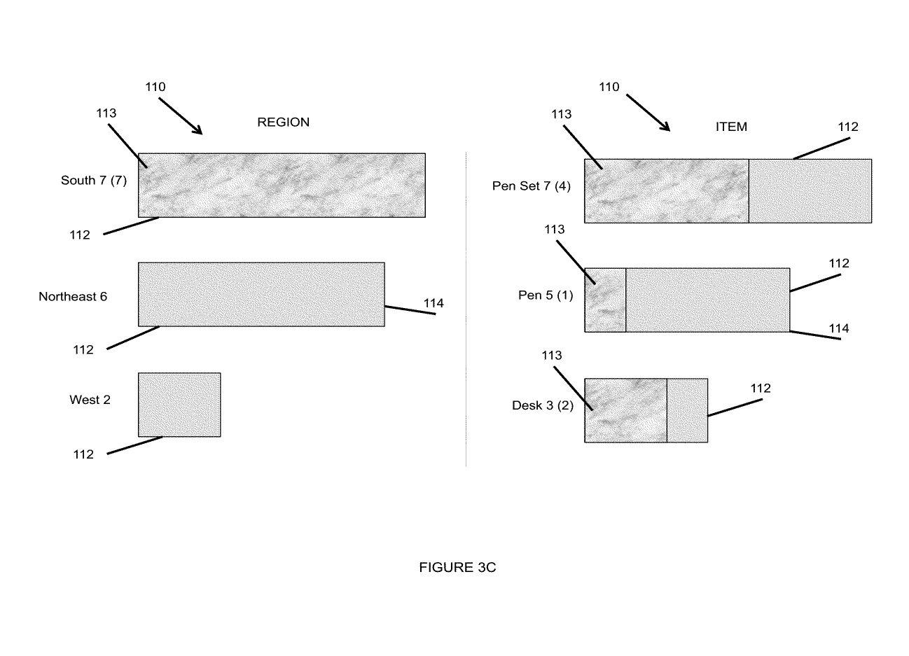

The memory 100G of the remote server 100 includes a software operating system OP.SYS 100H. The software OP.SYS 100H of computing device 100 may be selected from freely available, open source and/or commercially available operating system software, to include but not limited to a LINUX™ or UNIX™ or derivative operating system, such as the DEBIAN™ operating system software as provided by Software in the Public Interest, Inc. of Indianapolis, Ind.; a WINDOWS XP™, or WINDOWS 8™ operating system as marketed by Microsoft Corporation of Redmond, Wash.; or the MAC OS X operating system or iPhone G4 OS™ as marketed by Apple, Inc. of Cupertino, Calif. The memory 100G further includes a system software SW.CMP, a user input driver UDRV.CMP, a display driver DIS.CMP, a network interface drive NIF.CMP, and a DBMS 100A. The computing system software SW.CMP directs and enables the computing device to execute the invented method as presented in FIG. 2A through FIG. 3B.

It is understood that the computing system 100 may be or comprise a bundled computer software and hardware product such as, a.) a network-communications enabled THINKSTATION WORKSTATION™ notebook computer marketed by Lenovo, Inc. of Morrisville, N.C.; (b.) a NIVEUS 5200 computer workstation marketed by Penguin Computing of Fremont, Calif. and running a LINUX™ operating system or a UNIX™ operating system; (c.) a network-communications enabled personal computer configured for running WINDOWS XP™, or WINDOWS 8™ operating system marketed by Microsoft Corporation of Redmond, WA; or (d.) other suitable computational system or electronic communications device known in the art capable of providing or enabling a web service known in the art.

Referring now generally to the Figures, and particularly to FIG. 2A, FIG. 2A is a flowchart of an aspect of the invented method whereby a data set DATA.001-DATA.N is read by the computing device 100, is rendered in a table, and is subsequently rendered in a plurality of charts 104. In step 2.02 a data set DATA.001-DATA.N is selected by the computing device 100. The data set may be selected or imported from any suitable data organization methods or programs known in the art, including but not limited to Microsoft Excel™, as marketed by Microsoft Corporation of Redmond, Wash.. In step 2.04 a table is rendered within the program as directed by the system software SW.CMP. In step 2.06 a first column CMN.001 is selected by the computing device 100. In step 2.06 it is determined whether the selected column CMN.001 contains quantitative data QE.DATA.001, such as, in a non-limiting example, sales sums for individuals, for regions, or for specified products. When the computing device 100 determines in step 2.06 that the selected column CMN.001 contains quantitative data QE.DATA.001, the computing device 100 proceeds to step 2.10, wherein a quantitative bar chart 106 is generated based upon the selected column CMN.001-CMN.N. In step 2.12 the quantitative bar chart 106 is rendered on the screen 108 of the computing device 100.

Alternately, when the computing device 100 determines in step 2.06 that the selected column CMN.001-CMN.N does not contain quantitative data QE.DATA.001-QE.DATA.N, the computing device 100 proceeds to step 2.14 wherein a summary chart 110 is generated based upon the selected qualitative data, i.e. summary data SUM.DATA.001-SUM.DATA.N. In step 2.16 the summary chart 110 is rendered on the screen 108 of the computing device 100. The quantitative bar chart(s) 106 or the summary bar chart(s) 110 are generated automatically upon input of the data DATA.001-DATA.N into a table 102 within the program, and no input from a user is necessary to generate the quantitative bar chart(s) 106 or the summary bar chart(s) 110. Upon execution either of step 2.12 or of step 2.16, the computing device 100 proceeds to step 2.18, wherein the computing device 100 determines whether a final column CMN.001-CMN.N of the rendered table 102 has been generated in either a qualitative bar chart 106 or in a summary bar chart 110. When the computing device 100 determines in step 2.18 that the final column CMN.001-CMN.N has not been rendered, the computing device 100 proceeds to step 2.20, wherein the computing device 100 selects a next column CMN.001-CMN.N. The computing device 100 subsequently proceeds to step 2.08, wherein the computing device 100 executes the loop of steps 2.08 through 2.18 until it is determined in step 2.18 that the final column CMN.001-CMN.N has been rendered. When the computing device 100 determines in step 2.18 that the final column CMN.001-CMN.N of the generated table 102 has been rendered, the computing device 100 continues to alternate operations in step 2.22.

Referring now generally to the Figures, and particularly to FIG. 2B, FIG. 2B is an example of the product of the process of FIG. 2A. FIG. 2B is a screen view of an exemplary, non-limiting implementation of the invented method, wherein the invented method is applied to sales of a plurality of types of units of goods by a plurality of sales representatives, in a plurality of regions. A table 102 showing both quantitative data QE.DATA.001-QE.DATA.N and summary data SUM.DATA.001-SUM.DATA.N is additionally shown. The exemplary quantitative data QE.DATA.001-QU.DATA.N is within the columns CMN.001-CMN.N labeled “units,” and “amount,” and the exemplary summary data SUM.DATA.001-SUM.DATA.N is within the columns labeled “region,” “item,” and “salesperson.” The quantitative data QE.DATA.001-QE.DATA.N and summary data SUM.DATA.001-SUM.DATA.N are shown to be rendered in a plurality of both quantitative charts 106 and summary charts 110, rendered according to the specifications of the quantitative data QE.DATA.001-QE.DATA.N and summary data SUM.DATA.001-SUM.DATA.N in the table 102, wherein the quantitative charts 106 are labeled with the headings “units,” and “amounts,” and the summary charts are labeled with the headings “region,” “item,” and “salesperson.”

Referring now generally to the Figures, and particularly to FIG. 2C, FIG. 2C is a visual representation of two of the summary bar charts 110 of the representation of FIG. 2B, wherein the two displayed summary bar charts 110 are labeled “region,” and “item.” Under the summary bar chart 110 labeled “region” are the categories “south,” “northeast,” and “west”, and the under the bar chart 110 labeled “item,” the products “pen set,” “pen,” and “desk” are displayed.

Referring now generally to the Figures, and particularly to FIG. 3A, FIG. 3A is a flowchart of an aspect of the invented method whereby the computing device 100 highlights portions of the rendered quantitative data QE.DATA.001-QE.DATA.N and/or the rendered summary data SUM.DATA.001-SUM.DATA.N based upon a user selection input. The computing device proceeds from step 2.22 of the method of FIG. 2A to step 3.00, wherein the computing device 100 determines whether a user selection input of a chart element 112 has been received. The user may optionally enter a selection input of a chart element 112 by means of a point-and-click device communicatively coupled with the computing device 100, or optionally by means of a manual touch or tap on a touch screen the computing device 100, or by any other suitable input means known in the art. When the computing device 100 determines that no user selection input of a chart element 112 has been received, the computing device 100 proceeds to step 3.10, wherein the computing device executes alternate operations. Alternately, when the computing device 100 determines that a user selection input of a chart element 112 has been received, the computing device 100 proceeds to step optional 3.02. In optional step 3.02, the computing device optionally ceases rendering any shading 113 previously rendered as a result of previous user interaction, i.e. by a user selection of an alternate chart element 112. This optional step allows the user to begin interaction with the chart elements 112 with a clean slate, or optionally allows the user to build upon previous interactions with the chart elements 112, such that nuanced links between disparate chart elements 112 and quantitative data QE.DATA.001-QE.DATA.N and/or summary data SUM.DATA.001-SUM.DATA.N may be explored.

In step 3.04 the computing device 100 determines the contribution of a one or more selected chart element 112, particularly of one or more rows 114 of the rendered charts 104, to the remaining rendered charts 104. In step 3.06 the computing device 100 applies one or more algorithms to the one or more selected chart elements 112. The one or more algorithms applied to the selected chart elements 112 may include, but are not limited to, algorithms directed toward summing, generating an average, generating a mean, generating a median, or toward generating a maximum or a minimum value. Once an algorithm has been applied to the selected chart elements 112, the contribution of the selected elements 112 to the plurality of rendered charts 104 is rendered as a shading 113 overlaid over the rendered chart 104, wherein both the shading 113, and the totality of the chart 104 may be viewed by a user simultaneously, allowing for ease of perusal of particular subsets of either quantitative data QE.DATA.001-QE.DATA.N or of summary data SUM.DATA.001-SUM.DATA.N as they apply to the totality of rendered chart(s) 104. Additionally, the shading 113 may, particularly depending on the one or more algorithms applied, be any portion of the elements 112 of the charts 104, i.e. the shading 113 may cover an entire chart elements 112, none of a chart elements 112, or any fraction falling therebetween. The computing device 100 subsequently returns to step 3.00, and repeats the loop of steps 3.00 through 3.08 until the computing device determines in step 3.00 that no chart elements 112 selection has been received.

Referring now generally to the Figures, and particularly to FIG. 3B, FIG. 3B is a visual representation of the product of the method of FIG. 3A, wherein FIG. 3B shows a screen view of an exemplary, non-limiting implementation of the invented method, wherein the invented method is applied to sales of a plurality of types of units of goods by a plurality of sales representatives, in a plurality of geographic regions. FIG. 3B additionally shows prior art means by which visual data may be indicated, for example when a quantitative data set QE.DATA.001-QU.DATA.N is selected and the entirety of the chart element 112 corresponding to the selected is quantitative data set QE.DATA.001-QU.DATA.N is shaded indiscriminately, without regard to the corresponding input of other summary data sets SUM.DATA.01-SUM.DATA.N and/or quantitative data set QE.DATA.001-QU.DATA.N. A plurality of quantitative bar charts 106 and summary bar charts 110 are shown to have been rendered from the quantitative data QE.DATA.001-QE.DATA.N and from the summary data SUM.DATA.001-SUM.DATA.N, respectively. The summary data set SUM.DATA.01 having the heading category “south” is shown both in the table 102 (by a darkening of the highlighting over the summary data SUM.DATA.01 in the table 102) and in the summary bar chart 110 titled “region” to have been selected by a user. The relationship of the selected chart element 112 “south” to the other chart elements 112 displayed in the quantitative bar charts 106 and summary bar charts 110 is displayed as a shaded section 113 on each of the quantitative bar charts 106 and summary bar charts 110. In FIG. 3B, the shaded sections 113 of the chart elements 112 are shown with a marbling effect over the affected areas of the chart elements 112 in the summary bar charts 110, and as darkened areas in the chart elements 112 of the quantitative bar charts 106. As shown in the Figure, the geographic designation “south” has been selected, and so the contribution of the southern geographic region to both the quantitative bar charts 106 and the summary bar charts 110. Thus, a user may easily and quickly view the impact of the southern region throughout other sales metrics, including the type of item sold, the salesperson, and/or the total amount sold in an organized and simplified fashion. Additionally, a second chart element 112 and/or quantitative data set QE.DATA.001-QE.DATA.N and/or summary data set SUM.DATA.001-SUM.DATA.N may be selected, such that a user may view the affect of both inputs on the quantitative bar charts 106 and the summary bar charts 110. In a non-limiting example, both the geographic region “south,” and the item “pen set” may be selected, so that the impact of the item “pen set” in the southern region may be examined by the user.

Referring now generally to the Figures, and particularly to FIG. 3C, FIG. 3C shows additional detail in the visual representation of FIG. 3B, showing only the invented method of data visualization. The chart element 112 “south” has been selected by the user, either by means of a selection of the “south” chart element 112 itself, or by selection of the summary data SUM.DATA.001-SUM.DATA.N labeled “south” in the table 102. Because “south” is the chart element 112 being examined, the entirety of the “south” chart element is shaded, and neither of the other chart elements 112 representing regions (“northeast” and “west”) display any shading 113. Under the “item” heading are the chart elements 112 “pen set,” “pen,” and “desk,” and each of the chart elements 112 under the “item” heading display shading 113 over a portion thereof. The chart element 112 “south” represents seven total units, and the shading 113 over the bars 114 under the heading “item” also total seven units: the bar 114 titled “pen set” shows shading over four of seven units, the bar 114 titled “pen” shows shading over one of five units, and the bar 114 titled “desk” shows shading over two of three units, indicating that four of the seven pen sets, one of the five pens, and two of three desks, totaling seven units, were sold in the southern region.

Although FIG. 2B, FIG. 2C, FIG. 3A, FIG. 3B, and FIG. 3C demonstrate the means by which the invented method may be implemented through use of sales representatives and their profits, the range of the invented method is not, and should not be construed to be, limited to such a use. In an additional non-limiting example, the method may be applied to the polling numbers for politicians, whereby the names and statistics related to individuals running for political office may be inputted into the table 102, and may subsequently be sorted and organized by the above means. The method may additionally be applied to any statistical representation having both quantitative data QE.DATA.001-QU.DATA.N and summary data SUM.DATA.001- SUM.DATA.N as is deemed appropriate in the art. It may additionally be understood that total number of data inputs is inconsequential to the functioning of the method, and that there thus may any number of either quantitative or summary inputs as designated necessary by a user.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a non-transitory computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based herein. Accordingly, the disclosure of the embodiments of the invention is intended to be illustrative, but not limiting, of the scope of the invention, which is set forth in the following claims.

What is claimed is:

1. A computer-implemented method comprising:
a. Selecting a plurality of records (“data set”), each record comprising multivariate data;
b. Visually rendering a first representation of the data set, the first representation adapted to enable selection of at least one subset of the data set;
c. Visually rendering a second representation of distribution of the data set (“second representation”), the second representation corresponding to a segmentation of the data set in accordance with a dimension field of the data set;
d. Receiving a user selection from the first representation indicative of a first subset of records (“first subset”) of the data set; and
e. Visually indicating a degree of contribution of the first subset to the second representation.

2. The computer-implemented method of claim 1, wherein the first discrete component of the first representation represents quantitative data.

3. The computer-implemented method of claim 1, wherein the first discrete component of the first representation represents nonmetric data.

4. The computer-implemented method of claim 3, wherein the first discrete component of the first representation represents categorical data.

5. The computer-implemented method of claim 3, wherein the first discrete component of the first representation represents qualitative data.

6. The computer-implemented method of claim 1, further comprising:
f. Receiving a user selection of a second discrete component of the first representation; and
g. Visually indicating a degree of contribution of the second discrete component of the first representation to at least one discrete component of the second representation.

7. The computer-implemented method of claim 1, wherein the first representation comprises a bar chart.

8. The computer-implemented method of claim 1, wherein the first representation comprises a pie chart.

9. The computer-implemented method of claim 1, wherein the first representation comprises a first plurality of components sized in relation to quantitative counts.

10. The computer-implemented method of claim 1, wherein the first representation comprises a first plurality of components and the first plurality of components are segregated according to one of a plurality qualitative values of the first variate.

11. The computer-implemented method of claim 11, wherein first plurality of components of the first representation are sized in relation to quantitative counts.

12. The computer-implemented method of claim 1, wherein the visual indication of the degree of contribution of the first discrete component of the first representation to at least two discrete components of the second representation is visually rendered as a shading.

13. The computer-implemented method of claim 1, wherein the visual indication of the degree of contribution of the first discrete component of the first representation to at least two discrete components of the second representation is visually rendered as a distinctive coloring.

14. The computer-implemented method of claim 6, wherein the visual indication of the degree of contribution of the second discrete component of the first representation to at least two discrete components of the second representation is visually rendered as a shading.

15. The computer-implemented method of claim 6, wherein the visual indication of the degree of contribution of the second discrete component of the first representation to at least two discrete components of the second representation is visually rendered as a distinctive coloring.

16. The computer-implemented method of claim 1, further comprising visually indicating the first discrete component of the first representation after receipt of the user selection of the first discrete component of the first representation.

17. The computer-implemented method of claim 16, wherein the visual indication of the first discrete component of the first representation is visually rendered as a shading.

18. The computer-implemented method of claim 16, wherein the visual indication of the first discrete component of the first representation is visually rendered as a distinctive coloring.

19. The computer-implemented method of claim 16, further comprising:
h. Receiving a user selection of a second discrete component of the first representation;
i. Visually indicating a degree of contribution of the second discrete component of the first representation to at least one discrete component of the second representation;
j. Visually indicating the second discrete component of the first representation after receipt of the user selection of the second discrete component of the first representation.

20. The computer-implemented method of claim 19, wherein the visual indication of the second discrete component of the first representation is visually rendered as a shading.

21. The computer-implemented method of claim 19, wherein the visual indication of the second discrete component of the first representation is visually rendered as a distinctive coloring.

22. A computational system comprising:
Means to select a multivariate data set (“data set”);
Means to visually render a first representation of distribution of a first variate of a plurality of multivariate points of the data set (“first representation”);
Means to visually render a second representation of distribution of a second variate of the plurality of multivariate points of the data set (“second representation”);
Means to receive a user selection of a first discrete component of the first representation; and [symbol]
